(19) United States
(12) Patent Application Publication
(10) Pub. No.: US 2020/0269219 A1
(43) Pub. Date: Aug. 27, 2020

(54) UPCONVERSION LUMINESCENCE COUPLED TO PLASMONIC METAL NANOSTRUCTURES AND PHOTOACTIVE MATERIAL FOR PHOTOCATALYSIS

(71) Applicant: SABIC Global Technologies B.V., Bergen op Zoom (NL)

(72) Inventors: Hamdan AL-GHAMDI, Thuwal (SA); Habib KATSIEV, Thuwal (SA); Khaja WAHAB, Thuwal (SA); Hicham IDRISS, Thuwal (SA)

(21) Appl. No.: 15/733,044

(22) PCT Filed: Oct. 30, 2018
(86) PCT No.: PCT/IB2018/058503

§ 371 Date: Apr. 28, 2020

Related U.S. Application Data
(60) Provisional application No. 62/581,119, filed on Nov. 3, 2017.

(51) Int. Cl. B01J 27/04; B01J 23/52; B01J 35/00; B01J 37/04; B01J 37/34; B01J 37/02; C09K 11/77; C01B 3/32; B01J 19/12

(52) U.S. Cl. CPC B01J 27/04; B01J 2219/0875; B01J 35/0013; B01J 35/004; B01J 37/04; B01J 37/343; B01J 37/0215; C09K 11/7773; C01B 3/326; B01J 19/128; C01B 2203/0233; C01B 2203/1223; C01B 2203/1094; B01J 2219/1203; B01J 2219/0892; B01J 23/52

(57) ABSTRACT

Photoactive catalyst and methods of producing H₂ by photocatalytic water splitting. The photoactive catalyst includes an upconverting material, a photocatalyst material, and plasmonic metal nanostructures deposited on the surface of the photocatalyst material. The upconverting material is not embedded in or coated by the photocatalyst material. The upconverting material is capable of emitting light at a first wavelength that has an energy equal to or higher than the band gap of the photocatalyst material and at a second wavelength that can be absorbed by the plasmonic metal nanostructures.

### CROSS REFERENCE TO RELATED APPLICATIONS

This application claims the benefit of U.S. Provisional Patent Application No. 62/581,119 filed Nov. 3, 2017, which is hereby incorporated by reference in its entirety.

### BACKGROUND OF THE INVENTION

### A. Field of the Invention

The invention generally concerns photoactive catalysts for the generation of hydrogen (H₂) and optionally oxygen (O₂) from an aqueous solution. The photoactive catalyst is a tri-functional material that includes an upconverting material, a photocatalyst material, and plasmonic metal nanostructures on the surface of the photocatalyst material.

### B. Description of Related Art

Hydrogen (H₂) is a clean alternative to fuel. Conventional technology produces hydrogen on a commercial scale from steam reforming of methane. Due to the depletion of fossil fuels, there is a need to find an alternative feedstock to meet the growing demand for hydrogen production globally.

One alternative to methane steam reforming to produce hydrogen is through water-splitting. The reduction and oxidation half reactions for water-splitting are as follows:

2H⁺+2e⁻→H₂ (1)

H₂O+2h⁺→O₂+4H⁺ (2)

2H₂O→2H₂+O₂ (3)

Water-splitting can be achieved through electrolysis of water, photocatalytic splitting of water, or electrophotocatalytic splitting of water. A disadvantage of using photo-driven systems is that the light from the sun on earth suffers from its low energy density (about 1000 W/m² of land), thus requiring large areas for practical applications. Also, the main fraction of the solar spectrum is composed of infrared and visible light, which limits the range of photocatalysts that can be practically used. While considerable progress has been made in photovoltaic solar cells, their still relatively high cost makes them non-competitive compared to fossil fuel for energy intensive systems (such as those used in the chemical and transport industries and related systems). Photocatalytic materials are less efficient than photovoltaics, making them, to date, less practical for energy harvesting. Many limiting factors contribute to this lack of progress. Most photoactive semiconductor materials are either unstable in water, such as metal sulfide, or do not possess the electronic band edge requirements for the redox reaction needed for water splitting to occur. Equally important, most of the stable known semiconductors have large band gap (typically larger than 3 eV), including TiO₂, SrTiO₃, and GaN, which makes it difficult to develop applications that can practically compete with fossil fuel based processes. Over the last two decades, many approaches have been undertaken to overcome these limiting factors. These include multi junction semiconductor anion doping to decrease the band gap of wide band gap semiconductors, using upconverting materials to convert low-energy light to higher energy light (see U.S. Pat. App. Pub. No. 2011/0126889), using plasmonic metals to improve light harvesting and to decrease the charge carriers' recombination rates (see U.S. Pat. App. Pub. No. 2013/0168228), and employing specific 3D architectures also to increase light harvesting and to decrease recombination rates. Many of the previous approaches used core-shell and other multi-layered structures in which an upconverting material is embedded in or coated by a photocatalyst material (see PCT Pub. No. WO 2017/037599), which complicates and increases the cost of production.

While various attempts to produce water-splitting systems have been made, they do not appear to meet the demands for commercial-scale production of H₂ and O₂ from water. There exists a need for a photoactive catalyst that efficiently harnesses light energy using materials that can be economically produced.

### SUMMARY OF THE INVENTION

A discovery has been made that addresses at least some of the problems associated with currently available water-splitting processes. The discovery is premised on a photoactive catalyst that includes an upconverting material (e.g., NaYF₄—Yb doped with Tm), plasmonic metal nanoparticles (e.g., gold nanorods), and a photoactive material (e.g., CdS) arranged in a structure in which the upconverting material is not embedded in or coated by the photocatalyst material. For example, the upconverting material can be in separate particles from the photocatalyst material, and the plasmonic metal nanoparticles can be deposited on the surface of the photocatalyst material. The photoactive catalyst can be produced more economically than photoactive catalysts that have a core-shell structure and provides for efficient use of light energy for processes such as water splitting by converting low-energy photons to relatively high-energy photons.

As described in the specification and exemplified in the Examples, a photoactive catalyst according to the invention catalyzed production of H₂ by water splitting upon excitation with a 980 nm IR light (to excite the upconverting material). Applicants believe this is the first time that H₂ was made photocatalytically using plasmonic gold (Au) nanoparticles upon initial excitation with infrared light. Without wishing to be bound by theory, it is believed that generation of H₂ results in part from an upconversion process.

In one particular instance the photoactive catalyst can include (i) an upconverting material, (ii) a photocatalyst material, and (iii) plasmonic metal nanostructures deposited on the surface of the photocatalyst material, wherein the upconverting material is not embedded in or coated by the photocatalyst material, and wherein the upconverting material is capable of emitting light at a first wavelength that has an energy equal to or higher than the band gap of the photocatalyst material and at a second wavelength that can be absorbed by the plasmonic metal nanostructures. In some aspects, the upconverting material can include a lanthanide material or a doped lanthanide material. In some embodiments, the doped lanthanide material can include sodium yttrium tetrafluoride-ytterbium (NaYF₄—Yb) doped with thulium (Tm). In some aspects, the doped lanthanide material can include 15 to 25 mol % of Yb and 0.5 to 1.0 mol % of Tm. In some aspects, the NaYF₄—Yb doped with Tm is capable of absorbing light at a wavelength of 980 nm and emitting light at wavelengths of 800 nm and 477 nm. In some aspects, the photocatalyst material can include cadmium sulfide (CdS). In some aspects, the weight ratio of the upconverting material to the photocatalyst material is between 1:1 and 5:1. In some aspects, the upconverting material can be in particulate form. In some aspects, the upconverting material can have an average size between 5 and 500 nm. In some aspects, the photocatalyst material is in particulate form. In some aspects the photocatalyst material can have an average size between 3 and 20 nm. In some aspects, the photoactive catalyst can be deposited on a solid substrate, such as glass. In some aspects, the upconverting material is positioned next to or is in direct contact with the photocatalyst material.

The plasmonic metal particles can include a variety of materials and shapes. In some embodiments, the plasmonic metal nanostructures can include gold, copper, or silver nanostructures or alloys thereof. In some embodiments, the plasmonic metal particles can include gold nanorods capable of absorbing light with a wavelength between 500 and 1000 nm. In some embodiments, the gold nanorods can have a mean diameter of about 10 nm and a mean length of about 41 nm. In some embodiments, the weight ratio of the plasmonic metal nanostructures to the photocatalyst material can be from 0.1:100 to 1:100, or is about 0.25:100.

Also disclosed are methods of producing hydrogen gas. One method can include contacting methanol and water with any of the photoactive catalysts of the present invention while the photoactive catalyst is being irradiated by light comprising near infrared light. In some aspects, the methanol and water are in the gas phase when they contact the photoactive catalyst. In some aspects, the methanol and water are in the liquid phase when they contact the photoactive catalyst. In some aspects the near infrared light has a wavelength between 970 and 990 nm. In some aspects, the light that can include near infrared light is sunlight and/or an artificial infrared light source. In some aspects, the upconverting material can include NaYF₄—Yb doped with Tm. In some aspects, the photocatalyst material can include CdS. In some aspects, the plasmonic metal nanostructures can include gold nanorods. In some aspects, the NaYF₄—Yb doped with Tm absorbs 980 nm wavelength light and emits light at wavelengths of 800 nm and 477 nm.

Also disclosed are methods of making any of the photoactive catalysts of the present invention. A method can include: (i) mixing the upconverting material with the photocatalyst material having particles of the plasmonic metal nanostructures on the surface of the photocatalyst material in a liquid to make a suspension; (ii) sonicating the suspension; (iii) depositing the suspension on a solid substrate; and (iv) evaporating the liquid.

In the context of the present invention 20 embodiments are describes. Embodiment 1 is a photoactive catalyst comprising: (i) an upconverting material; (ii) a photocatalyst material; and (iii) plasmonic metal nanostructures deposited on the surface of the photocatalyst material; wherein the upconverting material is not embedded in or coated by the photocatalyst material; and wherein the upconverting material is capable of emitting light at a first wavelength that has an energy equal to or higher than the band gap of the photocatalyst material and at a second wavelength that can be absorbed by the plasmonic metal nanostructures. Embodiment 2 is the photoactive catalyst of embodiment 1, wherein the upconverting material comprises a lanthanide material or a doped lanthanide material. Embodiment 3 is the photoactive catalyst of embodiments 1 or 2, wherein the doped lanthanide material comprises sodium yttrium tetrafluoride-ytterbium (NaYF₄—Yb) doped with thulium (Tm), and wherein the photocatalyst material comprises cadmium sulfide (CdS). Embodiment 4 is the photoactive catalyst of embodiment 3, wherein the doped lanthanide material comprises 15 to 25 mol % of Yb and 0.5 to 1.0 mol % of Tm. Embodiment 5 is the photoactive catalyst of embodiments 3 or 4, wherein the NaYF₄—Yb doped with Tm is capable of absorbing light at a wavelength of 980 nm and emitting light at wavelengths of 800 nm and 477 nm. Embodiment 6 is the photoactive catalyst of any one of embodiments 1 to 5, wherein the plasmonic metal nanostructures comprise gold, copper, or silver nanostructures. Embodiment 7 is the photoactive catalyst of embodiment 6, wherein the plasmonic metal particles comprise gold nanorods capable of absorbing light with a wavelength between 500 and 1000 nm. Embodiment 8 is the photoactive catalyst of embodiment 7, wherein the gold nanorods have a mean diameter of 10 nm and a mean length of 41 nm. Embodiment 9 is the photoactive catalyst of any one of embodiments 1 to 8, wherein the weight ratio of the plasmonic metal nanostructures to the photocatalyst material is from 0.1:100 to 1:100 or is about 0.25:100. Embodiment 10 is the photoactive catalyst of any one of embodiments 1 to 9, wherein the weight ratio of the upconverting material to the photocatalyst material is between 1:1 and 5:1. Embodiment 11 is the photoactive catalyst of any one of embodiments 1 to 10, wherein the upconverting material is in particulate form and has an average size between 5 and 500 nm, and wherein the photocatalyst material is in particulate form and has an average size between 3 and 20 nm. Embodiment 12 is the photoactive catalyst of any one of embodiments 1 to 11, wherein the photoactive catalyst is deposited on a solid substrate, and wherein the upconverting material is positioned next to or is in direct contact with the photocatalyst material. Embodiment 13 is a method of producing hydrogen gas, the method comprising contacting methanol and water with the photoactive catalyst of any one of embodiments 1 to 12 while the photoactive catalyst is being irradiated by light comprising near infrared light. Embodiment 14 is the method of embodiment 13, wherein the methanol and water are in the gas phase when they contact the photoactive catalyst. Embodiment 15 is the method of embodiment 13, wherein the methanol and water are in the liquid phase when they contact the photoactive catalyst. Embodiment 16 is the method of any one of embodiments 13 to 15, wherein the near infrared light has a wavelength between 970 and 990 nm. Embodiment 17 is the method of any one of embodiments 13 to 16, wherein the light comprising near infrared light is sunlight and/or an artificial infrared light source. Embodiment 18 is the method of any one of embodiments 13 to 17, wherein the upconverting material comprises NaYF₄—Yb doped with Tm, wherein the photocatalyst material comprises CdS, and wherein the plasmonic metal nanostructures comprise gold nanorods. Embodiment 19 is the method of embodiment 18, wherein the NaYF₄—Yb doped with Tm absorbs 980 nm wavelength light and emits light at wavelengths of 800 nm and 477 nm. Embodiment is a method of making the photoactive catalyst of any one of embodiments 1 to 12, the method comprising: (i) mixing the upconverting material with the photocatalyst material having particles of the plasmonic metal nanostructures on the surface of the photocatalyst material in a liquid to make a suspension; (ii) sonicating the suspension; (iii) depositing the suspension on a solid substrate; and (iv) evaporating the liquid.

The following includes definitions of various terms and phrases used throughout this specification.

The terms “upconversion,” “upconverter,” “upconverting,” etc., refers to converting from a low energy to a high energy.

The phrase “electromagnetic radiation” refers to all wavelengths of light unless specified otherwise. Non-limiting examples of wavelengths of light include radio wave, microwave, infrared, visible light, ultraviolet, X-ray, and gamma radiation, or any combination thereof. In some preferred instances, the electromagnetic radiation can include ultraviolet light, visible light, infrared light, or a combination thereof.

The terms “about” or “approximately” are defined as being close to the value, term, or phrase that follows, as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The photocatalytic systems of the present invention can “comprise,” “consist essentially of” or “consist of” particular ingredients, components, compositions, etc. disclosed throughout the specification. With respect to the phrase “consist essentially of,” a basic and novel characteristic of the photoactive catalysts of the present invention is that these photoactive catalysts be used to produce H₂ by splitting water upon excitation with electromagnetic radiation. In some aspects, IR light can be used in this reaction to split water and produce H₂, which allows for a more efficient use of the solar spectrum.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 illustrates an embodiment of a photoactive catalyst.

FIGS. 2A-F depict (a) general energy schematic illumination related to the excited-state absorption process; (b-f) general energy schemes related to energy-transfer upconversion processes; (b) energy-transfer followed by excited-state absorption; (c) successive energy-transfers; (d) cross-relaxation upconversion; (e) cooperative sensitization; and (f) cooperative luminescence.

FIGS. 3A-C depicts a schematic of the upconversion mechanism of the Lanthanide materials (a) Yb³⁺ and Er³⁺, (b) Yb³⁺ and Tm³⁺, or (c) Yb³⁺ and Ho³.

FIG. 4 depicts a UV-Vis absorbance of NaYF₄—Yb—Tm showing absorbance at 910-1010 nm. (Top) full range scan, and (Bottom) narrow range scan.

FIG. 5A shows the effect of LASER excitation wavelength on emission of NaYF₄—Yb—Tm. Top, excitation with higher energy than absorbance. The absence of emission at 800 nm indicates that the material does not absorb this energy, in line with the results of FIG. 3. Middle, excitation at the absorbance edge and the simultaneous emission of the upconversion luminescence at 800 nm. Bottom, excitation with higher wavelength (lower energy) showing no emission, also in line with FIG. 3. Therefore, up-conversion occurs since an 800 nm emission is only observed when exciting the material in the absorbance range. KC19 (red filter) was used to cut-off any residual light from the excitation below 700 nm.

FIG. 5B shows the experimental setup for upconversion emissions of NaYF₄—Yb—Tm with excitation at 975 nm (+/−5 nm). A fraction of light was converted to the visible (477 nm) and IR (802 nm) ranges. KC19 (red filter) was used to cut-off any residual light from the excitation source below 700 nm. Filter C3C23 was used to attenuate light above 700 nm.

FIG. 6A shows UV-Vis absorbance spectra of bare CdS, 0.25 wt. % Au/CdS before reaction, and 0.25 wt. % Au/CdS/Upconverter after reaction (CdS to the upconverter (NaYF₄—Yb—Tm) ratio was 1 to 1).

FIG. 6B shows UV-Vis absorbance spectra of gold colloidal nanorods in water.

FIG. 7A depicts: (top) changes of volume of H₂ and CO₂ as a function of time; (bottom) background O₂ and CH₄ volume as a function of time for a phase photoreaction of methanol under 980 nm excitation on a system containing 0.25 wt. % Au—CdS/upconverter. Ambient-air+gas phase methanol. Humidity was about 50% at 20° C., 1 atm, which was equal to about 2 kPa. Methanol vapor pressure was about 10 kPa.

FIG. 7B depicts: (top) H₂ and CO₂ evolution with time; (bottom) O₂ and CH₄ profile with time for a reference gas phase photoreaction (in the absence of methanol) under 980 nm excitation on a system containing 0.25 wt. % Au—CdS/upconverter/ambient air.

FIG. 7C depicts: (top) H₂ and CO₂ evolution with time; (bottom) O₂ and CH₄ profile with time for reference gas phase photoreaction (in the absence of CdS) under 980 nm excitation on a system containing 0.25 wt. % Au-upconverter. Ambient-air+gas phase methanol. Humidity was about 50% at 20° C., 1 atm, which is equal to about 2 kPa. Methanol vapor pressure was about 10 kPa.

While the invention is susceptible to various modifications and alternative forms, specific embodiments thereof are shown by way of example in the drawings. The drawings may not be to scale.

### DETAILED DESCRIPTION OF THE INVENTION

Disclosed herein are compositions, systems, and methods that efficiently produce hydrogen through a photocatalytic water-splitting process. The compositions include an upconverting material, a photocatalyst material, and plasmonic metal nanostructures that together make up a photoactive catalyst that can harness electromagnetic radiation to catalyze production of hydrogen.

These and other non-limiting aspects of the present invention are discussed in detail in following sections.

### A. Photoactive Catalysts

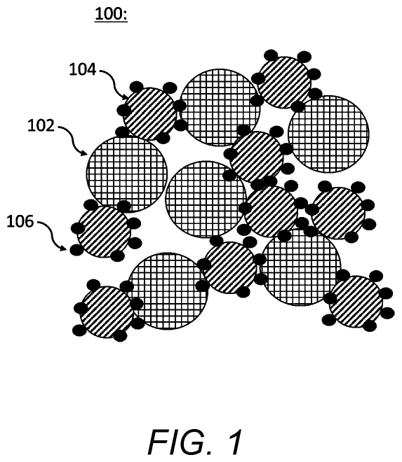

Photoactive catalysts disclosed herein include a photocatalyst material, an upconverting material, and metal or metal alloy nanoparticles that have plasmon resonance capabilities. The photoactive catalyst can include discrete particles of each of these components. A non-limiting illustration of such an embodiment is shown in FIG. 1. Referring to FIG. 1, the photoactive catalyst 100 can have particles of an upconverting material 102 in contact with particles of a photocatalyst material 104. The particles of photocatalyst material 104 can have plasmonic metal nanoparticles 106 deposited on their surfaces. The photoactive catalyst 100 can be deposited on a substrate (not shown), and the substrate with the photoactive catalyst 100 can be placed in a reaction chamber where the photoactive catalyst can catalyze chemical reactions. Without wishing to be bound by theory, it is believed that the close proximity of the particles of the upconverting material 102, the particles of the photocatalyst material 104, and the plasmonic metal nanostructures 106 enables the three types of particles to cooperatively harness electromagnetic energy to catalyze chemical reactions, such as water splitting. The absorption of relatively low-energy, near-infrared photons by the particles of upconverting material 102 and the subsequent emission of higher-energy photons by the particles of upconverting material 102 can expand the spectrum of light energy that can be used to catalyze chemical reactions such as water splitting compared to a bare photocatalyst material. The higher-energy photons emitted by particles of upconverting material 102 have energies that meet or exceed the band gap of the particles of the photocatalyst material 104 and/or can be absorbed by the plasmonic metal nanostructures 106. As shown, the particles of photocatalyst material 104 are smaller than the particles of upconverting material 102, but it should be understood that the particles of photocatalyst material 104 can be the same size as, or can be larger than, the particles of upconverting material 102. Likewise, the plasmonic metal nanostructures 106 can have one or more dimensions that are larger than, the same size as, or smaller than the particles of photocatalyst material 104 and/or the particles of upconverting material 102.

In embodiments disclosed herein, the upconverting material is not embedded in or coated by photocatalyst material. As used herein, a first material is “embedded in” a second material if at least 50% of its surface area is in physical contact with a contiguous mass of the second material. Thus, as an example, a particle of an upconverting material is not embedded in a photocatalyst material if the particle of the upconverting material is in physical contact with the photocatalyst material, but has less than 50% of its surface area in physical contact with a contiguous mass of the photocatalyst material. In addition, a particle of an upconverting material is not embedded in a photocatalyst material if more than 50% of its surface is in contact with a plurality of non-contiguous masses of photocatalyst material, such as discrete photocatalyst particles. Similarly, as used herein, a first material is “coated by” a second material if at least 50% of the first material's outermost surface area is in physical contact with a contiguous mass of the second material. As an example, if a layer of an upconverting material is deposited on a substrate and the layer of upconverting material has less than 50% of the light-facing surface area of the upconverting material in physical contact with a contiguous mass of the photocatalyst material, the layer of upconverting material is not coated by the photocatalyst material. In some embodiments, the upconverting material has no more than 5, 10, 15, 20, 25, 30, 35, 40, 45, or 50% of its surface area covered by a contiguous mass of photocatalyst material, or between any two of those values. In some embodiments the upconverting material has at least about, at most about, or about 5, 10, 15, 20, 25, 30, 35, 40, 45, 50, 55, 60, 65, 70, 75, or 80% of its surface area covered by a plurality of discrete photocatalyst particles.

A variety of photocatalyst materials, upconverting materials, and plasmonic metal nanostructures can be used in embodiments of photoactive catalysts disclosed herein. The materials may be chosen and tuned so as to provide that the upconverting material is capable of emitting light at a first wavelength that has an energy equal to or higher than the band gap of the photocatalyst material and at a second wavelength that can be absorbed by the plasmonic metal nanostructures. The particular material chosen for the photocatalyst material determines the band gap, or the amount of energy required to excite an electron in the material. The upconverting material properties, including the amount and type of dopant, can be chosen so as to provide emitted photons that have energy at least as high as the band gap of the photocatalyst material. It is also advantageous for the upconverting material to be capable of emitting photons that can be absorbed by, and stimulate surface plasmon resonance by the particular plasmonic metal nanostructures chosen. The inventors have achieved combinations of materials that are tuned to be able to cooperatively work together to harness light energy that would otherwise not be usable by conventional photoactive catalysts.

The weight ratio of the components of the photoactive catalyst can be chosen to provide for optimal efficiency in catalyzing chemical reactions such as water splitting. In some embodiments, the weight ratio of the upconverting material to the photocatalyst material is at least about, at most about, or about 0.1:1, 0.2:1, 0.3:1, 0.4:1, 0.5:1, 0.6:1, 0.7:1, 0.8:1, 0.9:1, 1:1, 1.5:1, 2:1, 2.5:1, 3:1, 3.5:1, 4:1, 4.5:1, 5:1, 6:1, 7:1, 8:1, 9:1, or 10:1, or between any two of these values. In preferred embodiments, the weight ratio is about 1:1. The weight ratio of plasmonic metal nanostructures to the photocatalyst material can also vary to provide for efficient capturing of light energy. In some embodiments, the weight ratio of the plasmonic metal nanostructures to the photocatalyst material is at least about, at most about, or about 0.1:100, 0.15:100, 0.2:100, 0.25:100, 0.3:100, 0.35:100, 0.40:100, 0.45:100, 0.5:100, 0.6:100, 0.7:100, 0.8:100, 0.9:100, or 1:100, or between any two of these values. In preferred embodiments, the weight ratio is 0.25:100.

1. Photocatalyst Material

The photocatalyst material can be made from any type of photoactive material that is capable of producing excited elections in response to ultraviolet and/or visible light. Non-limiting examples semiconductor materials include cadmium (Cd), strontium (Sr), titanium (Ti), cobalt (Co), thallium (Tl), and arsenic (As). Dopants such as phosphorous (P), sulfur (S) and barium (Ba) can be added. The photocatalyst material may be, for example, tungstic oxide (WO₃), titanium dioxide (TiO₂), titanium oxide (TiO), indium antimonide (InSb), lead (II) selenide (PbSe), lead (II) telluride (PbTe), indium (III) arsenide (InAs), lead (II) sulfide (PbS), germanium (Ge), gallium antimonide (GaSb), indium (III) nitride (InN), iron disillicide (FeSi2), silicon (Si), copper (II) oxide (CuO), indium (III) phosphide (InP), gallium (III) arsenide (GaAs), cadmium telluride (CdTe), selenium (Se), copper (I) oxide (Cu₂O), aluminum arsenide (AlAs), zinc telluride (ZnTe), gallium (III) phosphide (GaP), cadmium sulfide (CdS), aluminum phosphide (AlP), zinc selenide (ZnSe), silicon carbide (SiC), zinc oxide (ZnO), titanium (IV) oxide (TiO₂), gallium (III) nitride (GaN), zinc sulfide (ZnS), and mixtures and composites thereof. In a particular aspect, the photocatalyst material is CdS. The band gap of the photocatalyst material may be at least about, at most about, or about 0.5, 1, 1.5, 2, 2.5, 3, 3.5, 4, 4.5, 5, 5.5, 6, or 6.5 eV, or between any two of these values. The photocatalyst material may be capable of having an electron excited by light of at least about, at most about, or about 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 nm, or between any two of these values. In preferred embodiments, the photocatalyst material is capable of having an electron excited by light with a wavelength in the range of 450 to 500 nm, and in particular at a wavelength of about 477 nm.

In embodiments in which the photocatalyst material comprises a particle of the photocatalyst material, the particle may have a size (a largest dimension) of at least about, at most about, or about 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500 nm, or between any two of these values. These values may also be the mean particle size of particles of the photocatalyst material in a photoactive catalyst composition.

2. Upconverting Material

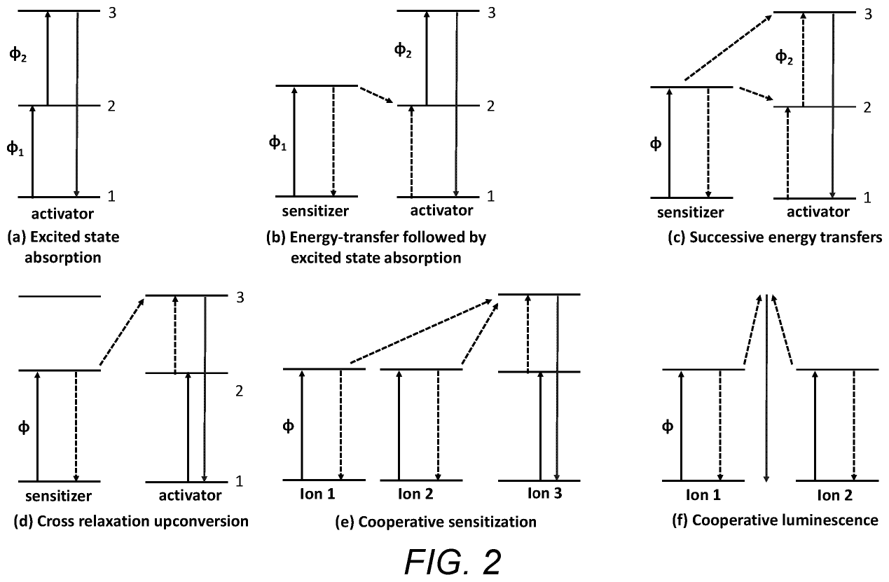

Upconverting (UC) luminescence is the sequential absorption of two or more photons (FIG. 2). A luminescent center in the ground state 1 can absorb energy from either an incoming photon or a corresponding energy transfer (ET) process to reach the excited state 2. Subsequently, another excitation (photon or a corresponding ET process) promotes the luminescent center from excited state 2 to excited state 3. A radiative transition from excited state 3 back to the ground state or some other lower-energy state, results in a higher-energy photon emission.

The UC process is a nonlinear optical process that involves metastable excited state intermediates. These metastable excited states need to have a relatively long lifetime in order to accumulate sufficient transient population before the arrival of subsequent photons. The UC process can take place through a number of complex pathways. The fundamental processes involved are excited state absorption (ESA), energy transfer (ETU) and photon avalanche (PA). Two main classes of materials have been studied for UC emission. These are the UC emission of lanthanide ions, Ln3+, such as Erbium (Er3+), Holium (Ho3+), and Thuluim (Tm3+) in an inorganic host, and the so called triplet-triplet annihilation (TTA)-based UC using pair of molecular dyes. Most of the reported UC emissive materials have incorporated lanthanide ions as sensitizers and emitters. The f electrons in the inner shells of Ln3+ ions are well shielded from the external chemical environment by the outer-lying s and p electrons. Due to these f states, Ln3+ ions have a large number of close energy levels characterized by long lifetimes, which can therefore facilitate multiple types of UC processes. These strongly shielded f states are rather insensitive to the surrounding host lattice (i.e., the crystal field and, to a lesser extent, the site symmetry), resulting in weak electron-phonon coupling. Consequently, the energy states of Ln3+ ions in varying host lattices are similar to those in free Ln3+ ions, with sharp and well defined spectroscopic features (10-20 nm FWHM). Lanthanide-doped materials have shown unique UC properties including large anti-Stokes shifts of several hundred nanometers (even >600 nm, about 2 eV), sharp emission lines, long UC lifetimes (in the ms range), and superior photo-stability.

Up-converting materials or salts thereof can be obtained through commercial chemical suppliers. In some aspects, the up-converting material can be nanocrystals or microcrystals synthesized using a dielectric matrix such as NaYF₄ or NaGdF₄ doped with lanthanide ions such as Yb, Er, or Tm in different ratios. A non-limiting example of a preferred up-converting material is NaYF₄—Yb doped with Tm. A non-limiting example of a commercial supplier of up-converting materials is Sigma-Aldrich® Co. LLC (St. Louis, Mo., USA).

In some embodiments in which the lanthanide material is NaYF₄—Yb doped with Tm, the lanthanide material may comprise at least about, at most about, or about 10, 11, 12, 13, 14, 15, 16, 17, 18, 19, 20, 21, 22, 23, 24, 25, 26, 27, 28, 29, or 30 mol. % of Yb, or between any two of these values. In preferred embodiments, the lanthanide material comprises about 20 mol. % of Yb. In some embodiments, the lanthanide material may comprise at least about, at most about, or about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2 mol. % of Tm, or between any two of these values. In preferred embodiments, the lanthanide material comprises about 0.75 mol. % of Tm. In preferred embodiments, the NaYF₄—Yb doped with Tm is capable of absorbing light at a wavelength of 980 nm and emitting light at wavelengths of 800 nm and 477 nm.

In embodiments in which the upconverting material comprises a particle of the photocatalyst material, the particle may have a size (a largest dimension) of at least about, at most about, or about 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500 nm, or between any two of these values. These values may also be the mean particle size of particles of the upconverting material in a photoactive catalyst composition.

3. Plasmonic Metals

The plasmonic materials in disclosed embodiments can be a metal or metal alloy having surface plasmon resonance properties in response to infrared light and/or visible light. Non-limiting examples of the metal or metal alloy includes silver (Ag), palladium (Pd), platinum (Pt), gold (Au), nickel (Ni), cobalt (Co), Rhodium (Rh), Ruthenium (Ru), Iridium (Ir) and copper (Cu) nanostructures, or any combination or alloy thereof. Without wishing to be bound by theory, it is believed that irradiating metal nanoparticles with light at their plasmon frequency can generate intense electric fields at the surface of the nanostructures. The frequency of this resonance can be tuned by varying the nanostructure size, shape, material, and proximity to other nanostructures. For example, the plasmon resonance of silver, which lies in the UV range, can be shifted into the visible range by making the nanostructures larger. Similarly, it is possible to shift the plasmon resonance of gold from the visible range into the IR by increasing the nanostructure size. Metal or metal alloys can be obtained from a commercial supplier such as Sigma-Aldrich® Co. LLC (St. Louis, Mo., USA). In some aspects, the average size of the largest dimension of the nanostructure in a photocatalyst composition is at least about, at most about, or about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 nm, or between any two of these values. In some embodiments, the nanostructures are spheres or nanorods. As used herein, a nanorods is a cylindrical nanostructure that has a ratio of length to diameter of at least 3:1. In some embodiments, nanorods in a photocatalyst have a mean diameter in the range of 5 to 15 nm, 7 to 12 nm, or 9 to 11 nm and a mean length in the range of 30 to 50 nm, 35 to 45 nm, or 39 to 42 nm. In preferred embodiments, the nanorods are gold and have a mean diameter of about 10 nm and a mean length of about 41 nm. In some embodiments the plasmonic metal nanostructures are capable of absorbing light with a wavelength of at least about, at most about, or about 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 nm, or between any two of these values.

### B. Methods of Producing H₂ by Photocatalytic Water Splitting

Methods of producing hydrogen gas include contacting methanol and water with a photoactive catalyst as described herein while the photoactive catalyst is being irradiated by light, which includes near infrared light. The methanol and water may be in either the gas phase or the liquid phase when they come into contact with the photoactive catalyst. The reaction may take place in a reaction chamber in which the photoactive catalyst has been placed. The photoactive catalyst may be deposited on a substrate, such as glass, before being placed in the reaction chamber. The reaction chamber may be at least partially transparent to allow irradiation of the photoactive catalyst by light from a source external to the reaction chamber. The light source may be a source that emits a range of wavelengths of electromagnetic radiation, including near infrared light. Such source may be, for example, the sun.

### C. Methods of Making a Photoactive Catalyst

Embodiments of photocatalysts disclosed herein have the advantage that they can be made by simple, cost-effective processes compared to, for example, core-shell structured photoactive catalysts or layered photoactive catalysts in which an upconverting material is embedded in or coated by a photocatalyst material.

A method of making a photoactive catalyst can include the step of mixing the following components in a liquid to make a suspension: an upconverting material, a photocatalyst material, and particles of the plasmonic metal nanostructures deposited on the surface of the photocatalyst. The upconverting material and photocatalyst material may be in particulate form, and the size of each may be at least about, at most about, or about 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500 nm, or between any two of these values.

Particles of each type of material may be obtained in separate processes. For example, particles of an upconverting material may be obtained by dissolving rare earth metal ions, such as Y³⁺, Yb³⁺ and/or Tm³⁺, for example, and an organic acid, such as citric acid, in aqueous solution, and adding a separate solution of a halide compound, such as NaF, for example, to the solution in a dropwise fashion. The resulting solution can then be treated hydrothermally, such as by autoclaving. The precipitated upconverting material can then be washed with water, ethanol or mixture thereof. The proportions of specific rare earth metal ions dissolved in the initial solution can be varied to alter the properties of the resulting upconverting material, such as the wavelengths of light absorbed and emitted.

Particles of a photocatalytic material can also be obtained by precipitation of an ionic solution containing component ions. For example, ions of a semiconductor, such as Cd, can be precipitated with ions of a dopant, such as S. The precipitated material can then be washed, dried and calcined. Plasmonic metal nanostructures can then be deposited on the surface of the photocatalytic material by suspending the photocatalytic material and the nanostructures together in a liquid, and then drying the suspension.

After mixing the upconverting material and photocatalyst/plasmonic metal nanostructure in a suspension, the suspension may be sonicated to help evenly distribute the materials. The liquid in which the suspension is made may be, for example, ethanol or water. After sonication, the suspension may be deposited on a solid substrate, and the liquid evaporated. Evaporation may take place with applied heat and/or in a vacuum. The substrate can be any suitable material, including glass, ceramic, polymer or the like.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Producing H₂ and CO₂ from Water and Methanol

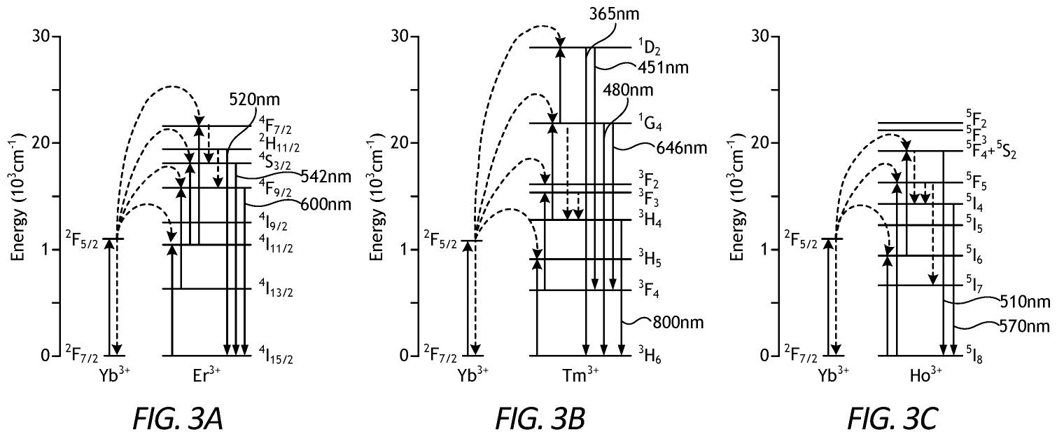

An inorganic host material NaYF₄ in which Yb cations are dispersed: NaYF₄—Yb was prepared. This results in light absorption at 980 nm which when doped with Er, Tm or Ho the up-converter emission takes place at difference wavelengths (FIG. 3). The absorbance at 980 nm and the emissions and lower wavelengths, need to be tuned with the semiconductor band gap as well as with the plasmon resonance energy, to fulfil the compositional and structural requirements.

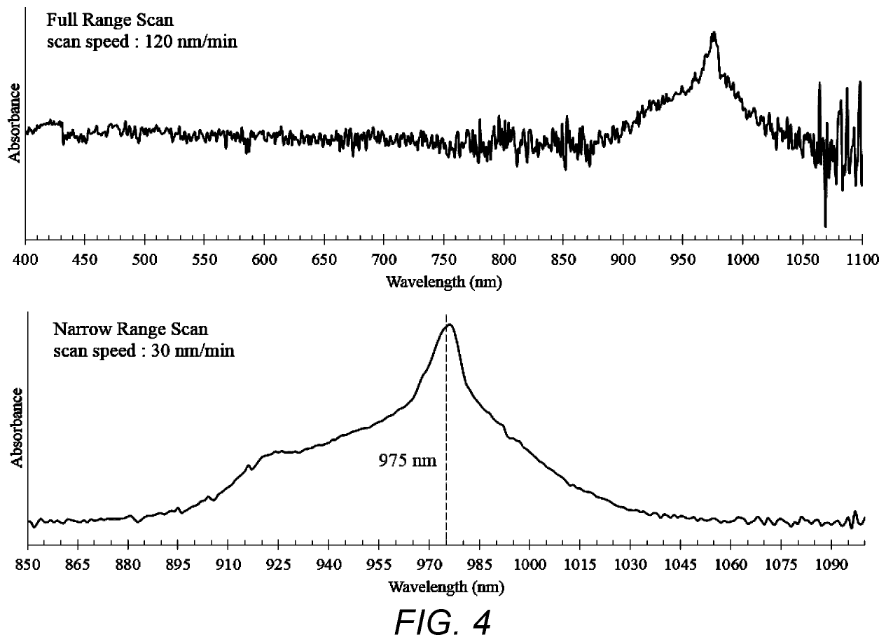

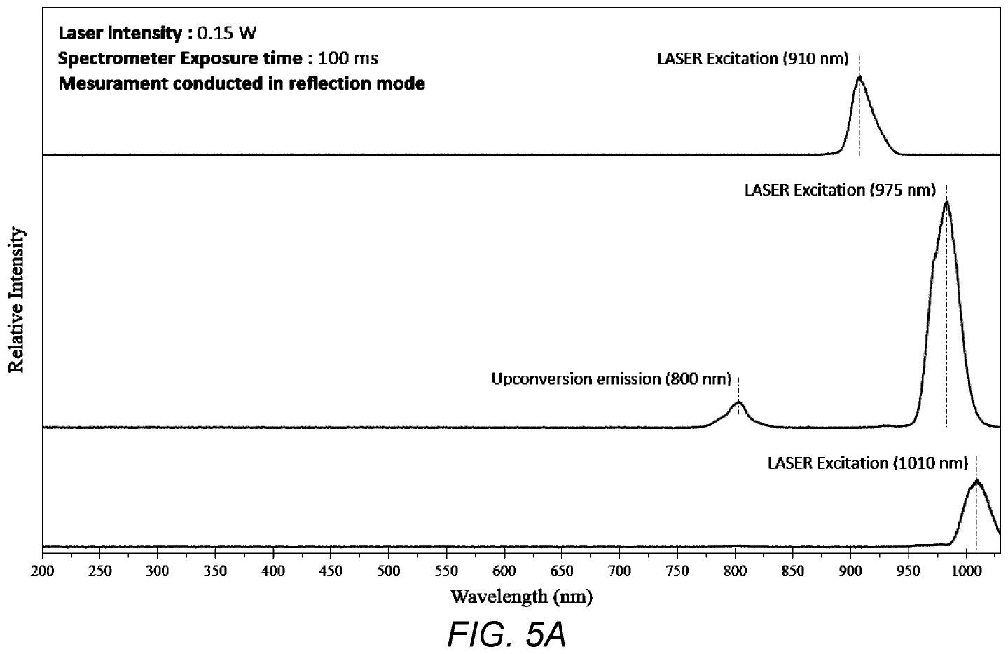

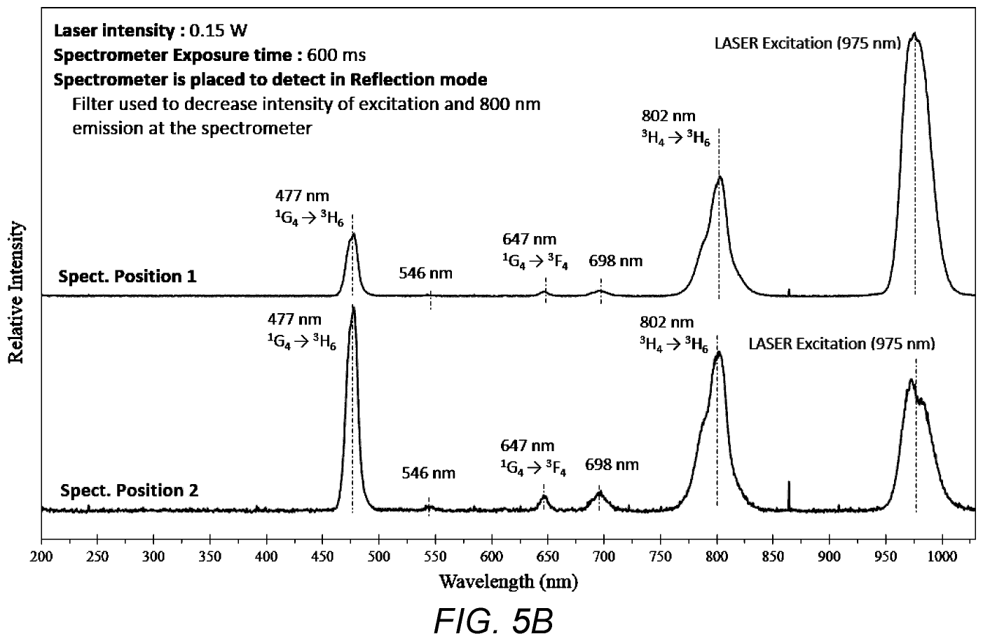

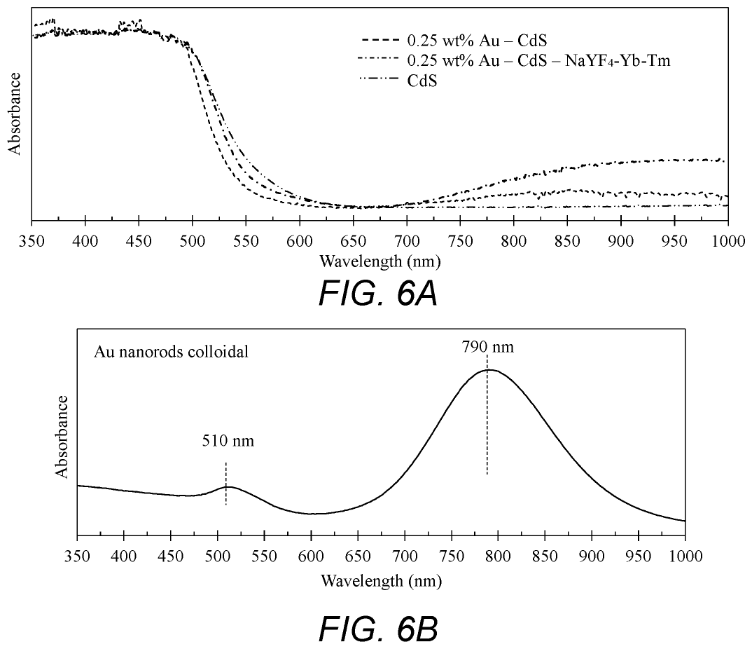

An upconverting material (NaYF₄—Yb, Tm) with Tm at 1.67% (with respect to Y and Yb) (FIG. 4) was prepared. FIGS. 5A-B show the sensitivity of the up converters to light frequency. The system was excited with a femtosecond laser which has a maximum power of 1 W/cm2 in the IR region. Up-conversion emission light at 800 nm and 477 nm was obtained. A CdS semiconductor (that absorbs around 500 nm) with Au nanorods (0.25 wt %, the remaining can be CdS) can be prepared as described below. Au nano-rods were measured for their particular plasmon resonance response in the IR and visible light range (FIG. 6 below). Such a combination can extend the Au plasmon energy into the IR region, which coincides with the absorbance edge of the up-converter (980 nm). Thus, enhancing light absorbance which in turn is poised to enhance light emission. Two solids 0.25 wt % Au/CdS (semiconductor+plasmon) with the NaYF₄—Yb—Tm (up-converter luminescence system) can be mixed together, in equal proportions. One can see in FIG. 6A that the presence of Au nanorods on top of CdS resulted in light absorption above 800 nm and extending up to 1000 nm; thus covering the absorption edge of the upconverting material.

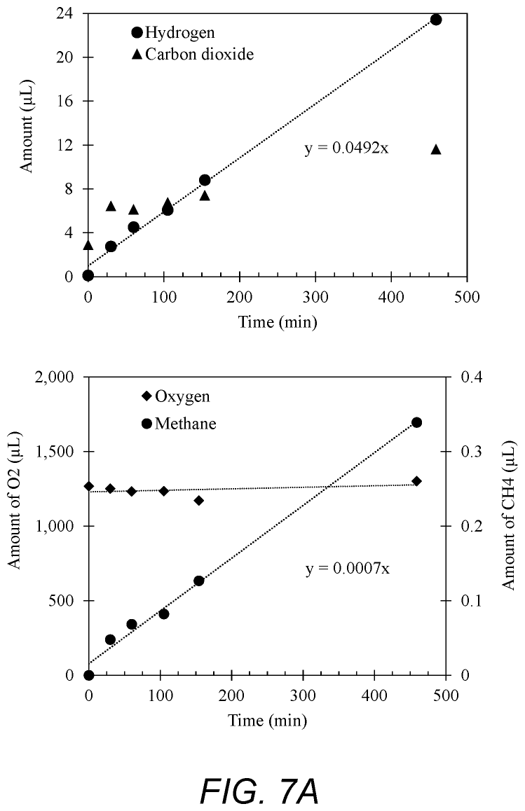

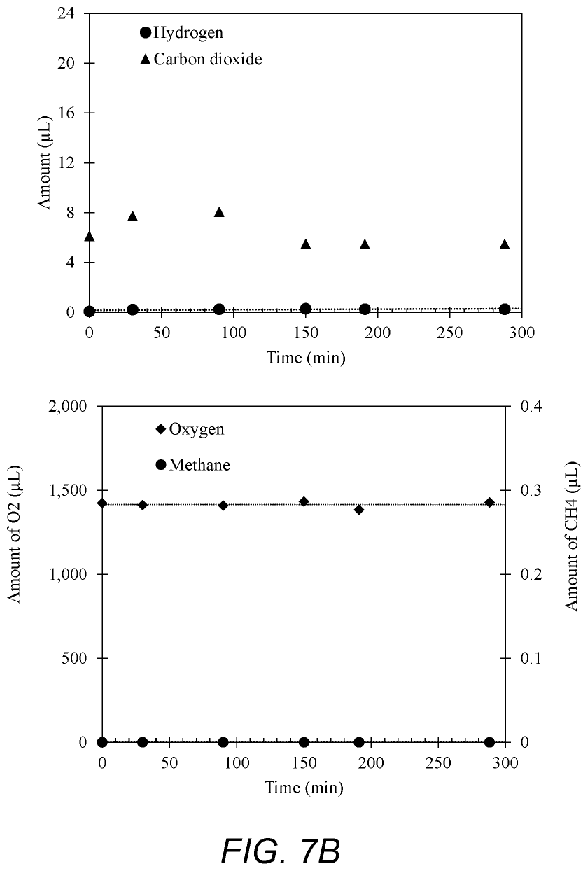

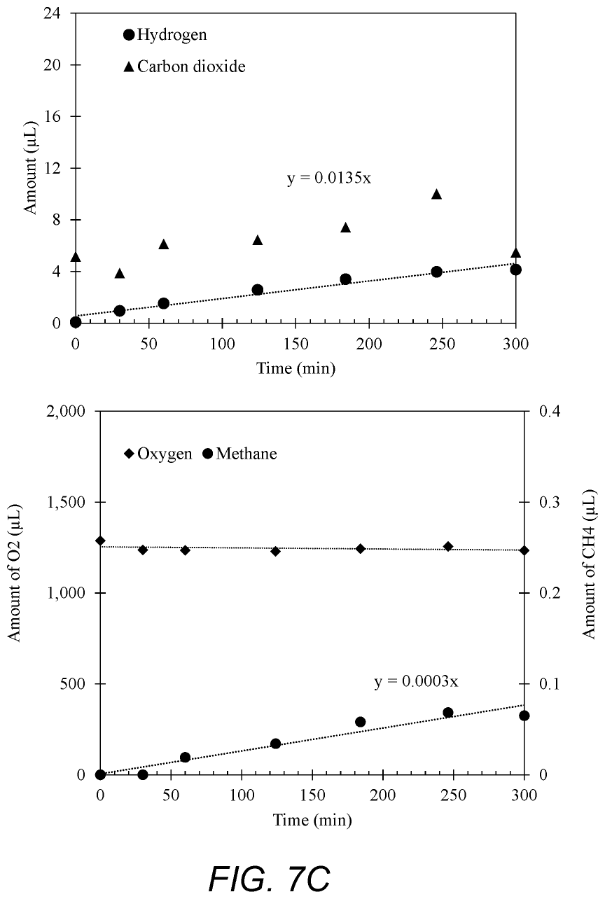

The obtained solid with the 980 nm laser (the absorbance edge of the up-converter) can be excited in the presence of gas phase methanol/air to produce hydrogen and CO2. CdS can only work with light in the visible range as its band gap corresponds to about 500 nm. This wavelength can be provided by the up-converter material since a fraction of the 980 nm light is converted to 802 nm and 477 nm which excite both the Au nano-rods (partly) and the CdS, respectively. The results were positive as both hydrogen and CO2 can be produced in the gas phase of the reactor (FIGS. 7A-C). The experiments were repeated in the absence of methanol (blank) and no reaction occurred. This indicates that hydrogen and CO2 do not originate from the ligand capping the nanorods. Then the system was tested without CdS but with Au nano-rods and a weak reaction was observed (about 0.25-0.30 of the activity obtained when CdS was present). This may indicate that hydrogen production may be in part originating from the direct catalytic reaction of the nanorods once excited with the first emission from the upconverter (the one at about 800 nm).

### Example 2

### Synthesis of NaYF₄-28% Yb-1.67% Tm Upconverter

0.538 g of Yttrium (III) nitrate hexahydrate, 0.260 g of Ytterbium (III) nitrate pentahydrate, and 0.015 g of Thulium (III) nitrate pentahydrate were dissolved in 75 mL de-ionized water. 5.777 g of citric acid was dissolved into the pre-mentioned mixture to obtain a concentration of 0.4 M and citric acid to rare earth metal ratio of 4. In a separate flask, 3.78 g of NaF were dissolved in 75 mL of de-ionized water to obtain a 1.2 M concentration. The two mixtures were left stirring for 1 hour after which the NaF solution was added to the rare earth metal solution dropwise. After mixing the two solutions, the resulting mixture was left stirring for half an hour at which time it was transferred into a Teflon-lined autoclave (where only ¾ of the autoclave was filled with solution). The solution was then treated hydrothermally at 180° C. for 24 hours. After completion, the resulting product was washed three times with de-ionized water and once with ethanol.

### Example 3

### Synthesis of Au/CdS/Upconverter Photocatalyst

A colloidal suspension of gold nanorods having a 10 nm diameter and 41 nm length was acquired from Sigma Aldrich® (USA). The gold nanorods absorb light with wavelength of 800 nm as reported (FIG. 4). Gold concentration was estimated by the vendor to be greater than 30 μg/mL in H₂O. The amount of cetyl trimethylammonium bromide, C₁₉H₄₂NBr (CTAB) ligand on the metal (used to stabilize the nanorods) was estimated by the manufacture to be <0.1 wt %. CdS was prepared by precipitation of Na₂S and CdNO₃ followed by calcination under inert atmosphere at 600° C. for four hours. 0.25 wt. % Au/CdS was made by mixing 120 mg of CdS with 10 mL of gold colloidal suspension and drying at 90° C. overnight under stirring. Similar preparation of Au/CdS was performed to obtain 0.25 wt. % Au/upconverter.

### Example 4

### Photoreaction at 980 nm Excitation

For the first photoreaction (FIG. 7A), 15 mg of (0.25 wt. % Au nanorods/CdS) was mixed with 15 mg of (NaYF₄-20 mol % Yb-0.75 mol % Tm) and sonicated in ethanol for several minutes. The mixture was then deposited on glass and the solvent dried at 70° C. Inside a 6 mL reactor, a drop of methanol was added along with the coated slide and the reactor was sealed. The catalyst was then excited with approximately 1 W/cm² at 980 nm excitation identical to the one in FIG. 5. Samples were analyzed by gas chromatography equipped with thermal conductivity detector and N₂ gas as a carrier gas. The first blank experiment (FIG. 7B) was conducted in the same manner with the exclusion of methanol in the system to eliminate the possibility of ligand (CTAB) degradation. The second blank experiment (FIG. 7C) was also conducted similarly without the semiconductor (CdS) in order to evaluate the contribution of CdS into the reaction.

1. A photoactive catalyst comprising:
(i) an upconverting material comprising a lanthanide material or a doped lanthanide material;
(ii) a photocatalyst material consisting of CdS; and
(iii) plasmonic metal nanostructures deposited on the surface of the photocatalyst material;
wherein the upconverting material is not embedded in or coated by photocatalyst material and the upconverting material is in physical contact with the photocatalyst material, but has less than 50% of its surface area in physical contact with a contiguous mass of the photocatalyst material; and
wherein the upconverting material is capable of emitting light at a first wavelength that has an energy equal to or higher than the band gap of the photocatalyst material and at a second wavelength that can be absorbed by the plasmonic metal nanostructures.

2. The photoactive catalyst of claim 1, wherein the upconverting material comprises a doped lanthanide material.

3. The photoactive catalyst of claim 2, wherein the doped lanthanide material comprises sodium yttrium tetrafluoride-ytterbium (NaYF₄—Yb) doped with thulium (Tm).

4. The photoactive catalyst of claim 3, wherein the doped lanthanide material comprises 15 to 25 mol % of Yb and 0.5 to 1.0 mol % of Tm.

5. The photoactive catalyst of claim 3, wherein the NaYF₄—Yb doped with Tm is capable of absorbing light at a wavelength of 980 nm and emitting light at wavelengths of 800 nm and 477 nm.

6. The photoactive catalyst of claim 5, wherein the plasmonic metal nanostructures comprise gold, copper, or silver nanostructures.

7. The photoactive catalyst of claim 6, wherein the plasmonic metal nanostructures comprise gold nanorods capable of absorbing light with a wavelength between 500 and 1000 nm.

8. (canceled)

9. The photoactive catalyst of claim 7, wherein the weight ratio of the plasmonic metal nanostructures to the photocatalyst material is from 0.1:100 to 1:100 or is 0.25:100.

10. The photoactive catalyst of claim 9, wherein the weight ratio of the upconverting material to the photocatalyst material is between 1:1 and 5:1.

11. (canceled)

12. The photoactive catalyst of claim 1, wherein the photoactive catalyst is deposited on a solid substrate, and wherein the upconverting material is positioned next to or is in direct contact with the photocatalyst material.

13. A method of producing hydrogen gas, the method comprising contacting methanol and water with the photoactive catalyst of claim 1 while the photoactive catalyst is being irradiated by light comprising near infrared light.

14. The method of claim 13, wherein the methanol and water are in the gas phase when they contact the photoactive catalyst.

15. The method of claim 13, wherein the methanol and water are in the liquid phase when they contact the photoactive catalyst.

16. The method of claim 13, wherein the near infrared light has a wavelength between 970 and 990 nm.

17. The method of claim 13, wherein the light comprising near infrared light is sunlight and/or an artificial infrared light source.

18. The method of claim 13, wherein the upconverting material comprises NaYF₄—Yb doped with Tm, and wherein the plasmonic metal nanostructures comprise gold nanorods.

19. The method of claim 18, wherein the NaYF₄—Yb doped with Tm absorbs 980 nm wavelength light and emits light at wavelengths of 800 nm and 477 nm.

20. A method of making the photoactive catalyst of claim 1, the method comprising the steps of:
(i) mixing the upconverting material with the photocatalyst material having particles of the plasmonic metal nanostructures on the surface of the photocatalyst material in a liquid to make a suspension;
(ii) sonicating the suspension;
(iii) depositing the suspension on a solid substrate; and
(iv) evaporating the liquid.
